(19) United States
(12) Patent Application Publication
(10) Pub. No.: US 2013/0283097 A1
(43) Pub. Date: Oct. 24, 2013

(54) DYNAMIC NETWORK TASK DISTRIBUTION

(71) Applicants: Zhongqian Chen, San Jose, CA (US); Xiaobing Han, San Jose, CA (US); Hui Wu, Fremont, CA (US); Hang Su, Sunnyvale, CA (US); Shenghong Zhu, Santa Clara, CA (US)

(72) Inventors: Zhongqian Chen, San Jose, CA (US); Xiaobing Han, San Jose, CA (US); Hui Wu, Fremont, CA (US); Hang Su, Sunnyvale, CA (US); Shenghong Zhu, Santa Clara, CA (US)

(73) Assignee: Yahoo! Inc., Sunnyvale, CA (US)

(21) Appl. No.: 13/452,998

(22) Filed: Apr. 23, 2012

(51) Int. Cl. G06F 9/46; G06F 11/14

(52) U.S. Cl. 714/16; 718/103; 714/E11.114

(57) ABSTRACT

Methods, systems, and programming for distributing tasks to a network of machines are disclosed. A plurality of tasks is received, each task having an associated priority level. Each of the plurality of tasks is assigned to a priority line of a plurality of priority lines based on the associated priority level of each of the plurality of tasks. A distribution strategy is determined for the plurality of tasks based on an analysis of at least one worker machine. A group of tasks is scheduled from the plurality of priority lines to a gateway line based on the distribution strategy. Tasks are pushed from the gateway line to the at least one worker machine to process the tasks. The progress of tasks processed by worker machines is monitored and results of tasks are fetched and delivered to users of user devices.

### FIELD

The present disclosure relates to methods, systems and programming for distributing tasks to a network of machines. More particularly, the present disclosure is directed to methods, systems, and programming for dynamic distribution of tasks to a network of machines to maximize utilization of available computational resources.

### BACKGROUND OF THE INVENTION

It is a very typical problem for a system or network to have multiple types of tasks for processing, where each task type may include a different requirement on computational resources. For example, each task may have an associated urgency, processing time, and fault tolerance. A task is defined as any piece of work requiring computational resources. For instance, a crawler of a search engine must fetch each web page, and this can be considered as a task. Different demands may be made on the search engine's resources depending on the search engine or web server's geo-location, capacity, and network bandwidth. Other tasks carried out by web servers such as attempting to retrieve or process data also require computational resources.

Typically, the web server or search engine may deploy the tasks to any number of worker machines (or hosts) to perform the tasks. However, in a network, small or large, machines may have different processing capacity stemming from differences in central processing unit (CPU), memory, storage, and network bandwidth capabilities. Additionally, machines that are manufactured by different manufacturers may also have different capabilities and computational processing resources. Even if all machines had the same processing capacity, the resources could not be allocated evenly to handle tasks of different importance and priority.

### SUMMARY

The present disclosure relates to methods, systems and programming for distributing tasks to a network of machines. More particularly, the present disclosure is directed to methods, systems, and programming for dynamic distribution of tasks to a network of machines to maximize utilization of available computational resources.

In an embodiment a method implemented on at least one computing device, each computing device having at least one processor, storage, and a communication platform connected to a network for distributing tasks to a network of machines, is disclosed. A plurality of tasks is received, each task having an associated priority level. Each of the plurality of tasks is assigned to a priority line of a plurality of priority lines based on the associated priority level of each of the plurality of tasks. A distribution strategy is determined for the plurality of tasks based on an analysis of at least one worker machine. A group of tasks is scheduled from the plurality of priority lines to a gateway line based on the distribution strategy. Tasks are pushed from the gateway line to at least one worker machine to process the tasks.

In another embodiment, the plurality of tasks relate to tasks required by a search engine.

In another embodiment, scheduling a group of tasks from the plurality of priority lines to a gateway line based on the distribution strategy comprises: determining a distribution of tasks based on a number of tasks in each of the plurality of priority lines; and pushing tasks from each of the plurality of priority lines based on the determined distribution.

In another embodiment, determining a distribution strategy for the plurality of tasks based on an analysis of at least one worker machine comprises: analyzing a progress of a queue of each of at least one worker machine.

In another embodiment, a new distribution strategy may be determined at predetermined time intervals in response to new tasks received and assigned to the plurality of priority lines.

In another embodiment, a progress of each of at least one worker machine processing the pushed tasks may be monitored.

In another embodiment, a failed task is determined at a worker machine. A reason associated with the failed task is determined. The failed task is reinserted into a queue at the worker machine for reprocessing of the failed task.

In an embodiment, a system for distributing tasks to a network of machines is disclosed. The system includes a serialization unit for receiving a plurality of tasks, each task having an associated priority level, and assigning each of the plurality of tasks to a priority line of a plurality of priority lines based on the associated priority level of each of the plurality of tasks; and a distribution unit for determining a distribution strategy or the plurality of tasks based on an analysis of at least one worker machine, scheduling a group of tasks from the plurality of priority lines to a gateway line based on the distribution strategy, and pushing tasks from the gateway line to at least one worker machine to process the tasks.

In another embodiment, the plurality of tasks relate to tasks required by a search engine.

In another embodiment, the distribution unit is further configured for determining a distribution of tasks based on a number of tasks in each of the plurality of priority lines; and pushing tasks from each of the plurality of priority lines based on the determined distribution.

In another embodiment, the distribution unit is further configured for analyzing a progress of a queue of each of the at least one worker machine.

In another embodiment, the distribution unit is further configured for determining a new distribution strategy at predetermined time intervals in response to new tasks received and assigned to the plurality of priority lines.

In another embodiment, the system further includes a monitoring unit for monitoring a progress of each of the at least one worker machine processing the pushed tasks.

In another embodiment, the distribution unit is further configured for determining a failed task at a worker machine; determining a reason associated with the failed task; and reinserting the failed task into a queue at the worker machine for reprocessing of the failed task.

Other concepts relate to software for implementing adaptive application searching. A software product, in accord with this concept, includes at least one machine-readable non-transitory medium and information carried by the medium. The information carried by the medium may be executable program code data regarding parameters in association with a request or operational parameters.

In an embodiment, a machine readable and non-transitory medium having information recorded thereon for distributing tasks to a network of machines, where when the information is read by the machine, causes the machine to receive a plurality of tasks, each task having an associated priority level; assign each of the plurality of tasks to a priority line of a plurality of priority lines based on the associated priority level of each of the plurality of tasks; determine a distribution strategy for the plurality of tasks based on an analysis of at least one worker machine; schedule a group of tasks from the plurality of priority lines to a gateway line based on the distribution strategy, and push tasks from the gateway line to the at least one worker machine to process the tasks.

In another embodiment, the plurality of tasks relate to tasks required by a search engine.

In another embodiment, scheduling a group of tasks from the plurality of priority lines to a gateway line based on the distribution strategy comprises: determining a distribution of tasks based on a number of tasks in each of the plurality of priority lines; and pushing tasks from each of the plurality of priority lines based on the determined distribution.

In another embodiment, determining a distribution strategy for the plurality of tasks based on an analysis of at least one worker machine comprises: analyzing a progress of a queue of each of the at least one worker machine.

In another embodiment, a new distribution strategy may be determined at predetermined time intervals in response to new tasks received and assigned to the plurality of priority lines.

In another embodiment, a progress of each of the at least one worker machine processing the pushed tasks may be monitored.

In another embodiment, a failed task is determined at a worker machine. A reason associated with the failed task is determined. The failed task is reinserted into a queue at the worker machine for reprocessing.

Additional advantages and novel features will be set forth in part in the description which follows, and in part will become apparent to those skilled in the art upon examination of the following and the accompanying drawings or may be learned by production or operation of the disclosed embodiments. The advantages of the present embodiments may be realized and attained by practice or use of various aspects of the methodologies, instrumentalities and combinations set forth in the detailed description set forth below.

### BRIEF DESCRIPTION OF THE DRAWINGS

FIG. 1 depicts a high level exemplary system diagram of a scheduling server and worker machines in accordance with an embodiment of the present disclosure.

FIG. 2 is a high level depiction of an exemplary system 200 in which a web server, distributed service scheduling server, and worker machines are deployed to provide dynamic distribution of tasks to a network of machines to maximize utilization of available computational resources, in accordance with an embodiment of the present disclosure.

FIG. 3 is a high level depiction of an exemplary system 300 in which a web server, distributed service scheduling server, and worker machines are deployed to provide dynamic distribution of tasks to a network of machines to maximize utilization of available computational resources, in accordance with an embodiment of the present disclosure.

FIG. 4 depicts a high level exemplary system diagram of a distributed service scheduling server with worker machines in accordance with an embodiment of the present disclosure.

FIG. 5 depicts a flowchart of an exemplary process in which tasks are distributed to worker machines and in which distribution of tasks to worker machines are updated in accordance to an embodiment of the present disclosure.

FIG. 6 depicts a flowchart of an exemplary process of a serialization step taken by a distributed service scheduling server in accordance with an embodiment of the present disclosure.

FIG. 7 depicts a flowchart of an exemplary process of a distribution step taken by a distributed service scheduling server in accordance with an embodiment of the present disclosure.

FIG. 8 depicts a high level exemplary system diagram of a distributed service scheduling server in accordance with an embodiment of the present disclosure.

FIG. 9 depicts a flowchart of an exemplary process of handling task failures in accordance with an embodiment of the present disclosure.

FIG. 10 depicts a flowchart of an exemplary process in which tasks are scheduled to worker machines in accordance with an embodiment of the present disclosure.

FIG. 11 depicts a general computer architecture on which the present embodiments can be implemented and has a functional block diagram illustration of a computer hardware platform which includes user interface elements.

### DETAILED DESCRIPTION

In the following detailed description, numerous specific details are set forth by way of examples in order to provide a thorough understanding of the relevant embodiments described herein. However, it should be apparent to those skilled in the art that the present embodiments may be practiced without such details. In other instances, well known methods, procedures, components and/or circuitry have been described at a relatively high-level, without detail, in order to avoid unnecessarily obscuring aspects of the embodiments described herein.

The present disclosure relates to methods, systems and programming for distributing tasks to a network of machines. More particularly, the present disclosure is directed to methods, systems, and programming for dynamic distribution of tasks to a network of machines to maximize utilization of available computational resources. The embodiments described herein solve the problem of simultaneous serving of a variety of tasks of varying priorities which require different response times. Tasks are organized into separate queues where each queue is assigned a priority that corresponds with tasks of a given priority. Tasks are dynamically mingled from different queues based on the queue priorities. The mingled tasks are then distributed to a network of machines that may all have varying processing capacities to complete the tasks in an efficient manner while maximizing the utility of the resources of all machines in the network.

The embodiments describe herein may be utilized by web servers that assign data to worker machines, and more specifically to web search engines that need to perform a variety and large number of tasks to ensure efficient operation. Especially in the realm of web searching, search engines need to have the ability to distribute tasks to worker machines in an efficient manner to ensure up to date search results, and fast provision of search results to users of user devices. For example, generation of web page snapshots in the form of images may be deemed tasks. However, due to varying web page structures, certain images may require more resources from worker machines for snapshot generation. Thus, the embodiments described herein facilitate dynamic distribution of tasks to worker machines to leverage the computing and processing capacity of each worker machine. Since these web page snapshots may be provided as viewable and actionable search results that link to a corresponding web page URL, refreshment of the snapshots may also be a task that can be made more efficient in accordance with the embodiments described herein.

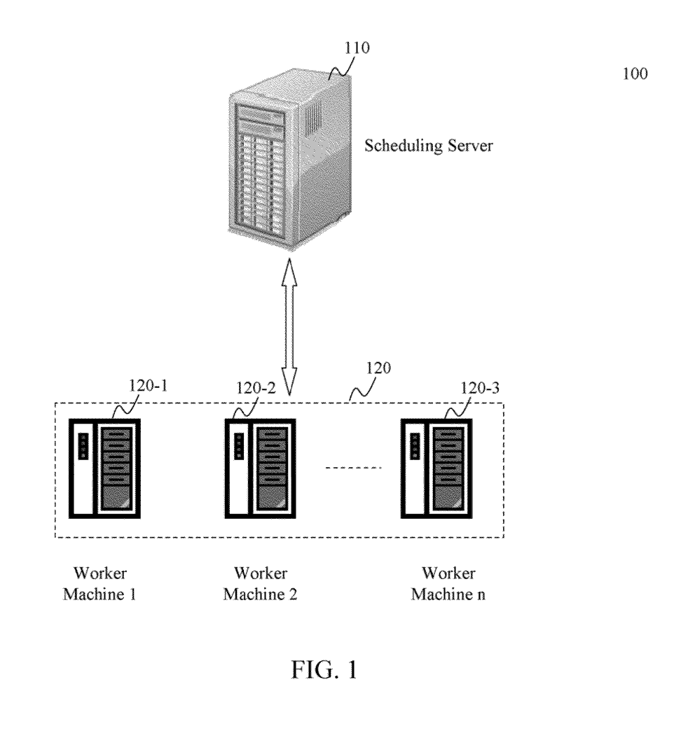

FIG. 1 depicts a high level exemplary system diagram of a scheduling server and worker machines in accordance with an embodiment of the present disclosure. System 100 includes scheduling server 110 and worker machines 120. Scheduling server 110 receives tasks to process, for example, from a web server, or directly from a user device. Scheduling server 110 processes the tasks and determines a distribution strategy for distributing the tasks to a plurality of worker machines 120 for completion. Scheduling server 110 may monitor the progress of task completion and distribution and dynamically adjust the distribution strategy accordingly.

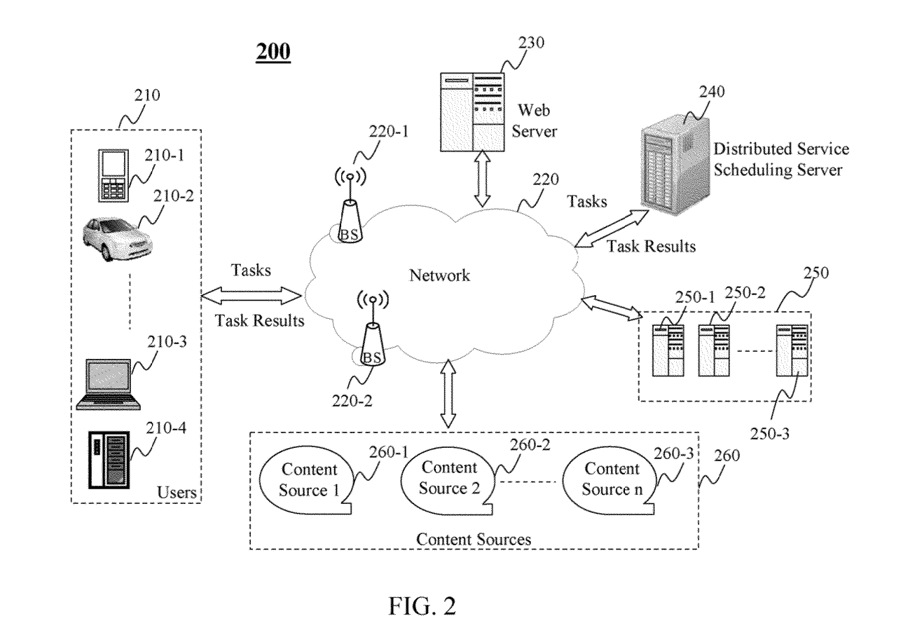

FIG. 2 is a high level depiction of an exemplary system 200 in which a web server, distributed service scheduling server, and worker machines are deployed to provide dynamic distribution of tasks to a network of machines to maximize utilization of available computational resources, in accordance with an embodiment of the present disclosure. Exemplary system 200 includes users 210, network 220, web server 230, content sources 260, distributed service scheduling server 240, and worker machines 250. Network 220 can be a single network or a combination of different networks. For example, a network may be a local area network (LAN), a wide area network (WAN), a public network, a private network, a proprietary network, a Public Telephone Switched Network (PTSN), the Internet, a wireless network, a virtual network, or any combination thereof. A network may also include various network access points, e.g., wired or wireless access points such as base stations or Internet exchange points 220-1, . . . , 220-2, through which a data source may connect to in order to transmit information via the network.

Users 210 may be of different types such as users connected to the network via desktop connections (210-4), users connecting to the network via wireless connections such as through a laptop (210-3), a handheld device (210-1), or a built-in device in a motor vehicle (210-2). A user may require access to web server 230, or content sources 260. Thus, communication between users 210 and web server 230 and/or content sources 260 may require tasks which can be forwarded to distributed service scheduling server 240 to process and distribute to worker machines 250. For example, a download of an application or other data from content source 260-1 to user 210-1 may be a task which can be handled by distributed service scheduling server 240. Likewise, retrieving search results or updates of snapshots that are viewable and actionable to provide to users 210 for display may require that certain tasks be processed by distributed service scheduling server 240. Tasks required by web server 230 may also be sent to distributed service scheduling server 240. For example, fetching web pages can be tasks distributed by distributed service scheduling server 240 to worker machines 250. Additionally, creation and updating of snapshots used as web search results that are provided by web server 230 to users 210 are also tasks that can be distributed by distributed service scheduling server 240 to worker machines 250.

The content sources 260 include multiple content sources 260-1, 260-2, . . . , 260-3. A content source may correspond to a web page host corresponding to an entity, whether an individual, a business, or an organization such as the USPTO represented by USPTO.gov, a content provider such as Yahoo.com, or a content feed source such as Twitter or blog pages. It is understood that any of these content sources may be associated with search results provided to users 210. For example, a search result may include a snapshot linking to a content source. In order to provide search results and snapshots linking to a content source, content sources 260 may require that distributed service scheduling server 240 distribute these tasks for worker machines 250 to complete. Web server 230, distributed service scheduling server 240, and worker machines 250 may access information from any of content sources 260 and rely on such information to complete tasks, including, but not limited to generating web page snapshots, responding to search requests, and providing search results.

In exemplary system 200, distributed service scheduling server 240 receives tasks from any of users 210, content sources 260, or web server 230. Tasks are assigned to worker machines 250 for completion based on the priority levels associated with the tasks and leverage the computational resources of worker machines 250 to the extent that all worker machines 250 will complete processing of their respective tasks at approximately the same time. All tasks received by distributed service scheduling server 240 are all processed and analyzed to generate a distribution strategy. On the basis of this distribution strategy, tasks are distributed to worker machines 250 for completion. For example, if worker machine 250-1 and worker machine 250-2 are both twice as efficient as worker machine 250-3, then worker machine 250-1 and 250-2 will be assigned tasks proportionately and commensurate with their increased computational resources.

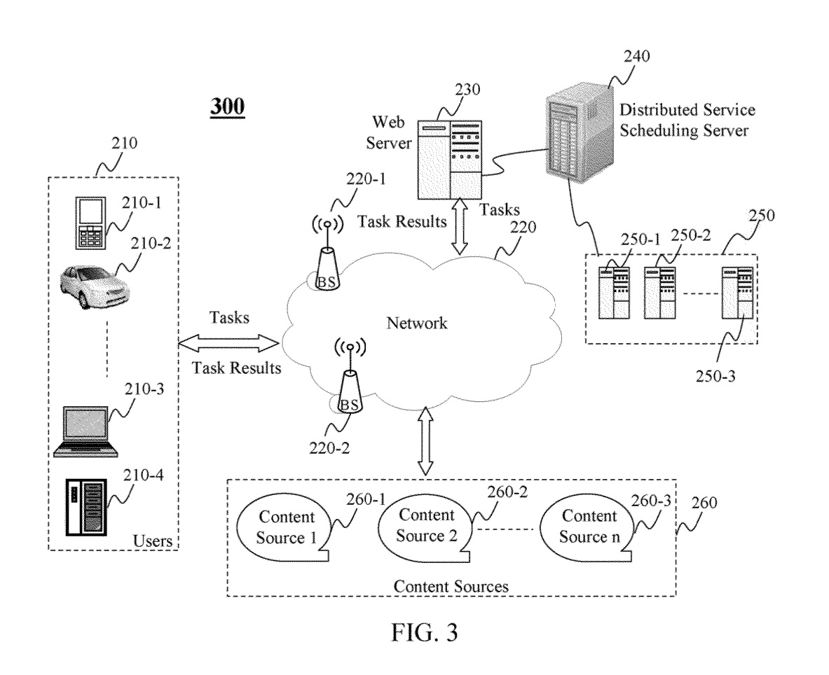

FIG. 3 is a high level depiction of an exemplary system 300 in which a web server, distributed service scheduling server, and worker machines are deployed to provide dynamic distribution of tasks to a network of machines to maximize utilization of available computational resources, in accordance with an embodiment of the present disclosure. In this embodiment, distributed service scheduling server 240 and worker machines 250 serve as backend systems of web server 230. All communication to and from distributed service scheduling server 240 and worker machines 250 are sent and received through web server 230.

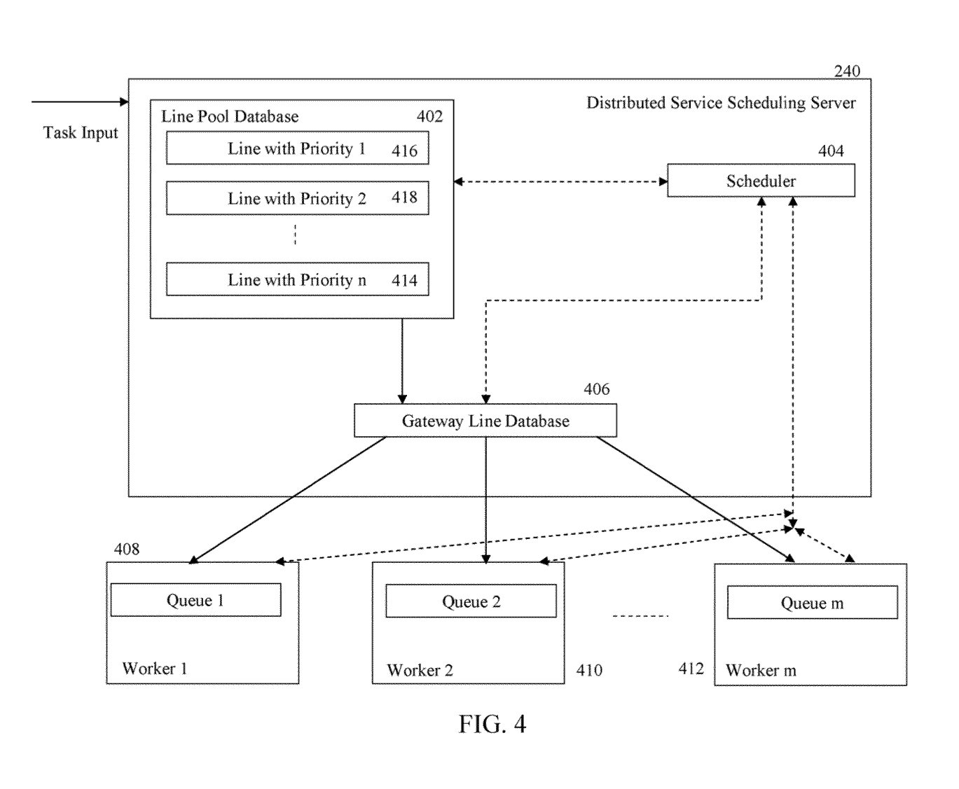

FIG. 4 depicts a high level exemplary system diagram of a distributed service scheduling server with worker machines in accordance with an embodiment of the present disclosure. System 400 includes distributed service scheduling server 240 and worker machines 408, 410, and 412. Although three worker machines are shown in FIG. 4, any number of worker machines may be utilized in accordance with the embodiments described herein. Distributed service scheduling server 240 includes line pool database 402, scheduler 404, and gateway line database 406. In distributed service scheduling server 240, the quality or priority of each task is mapped into a positive numerical value termed a priority value. The larger the priority value, the higher the priority of the task. Distributed service scheduling server 240 receives tasks as input. These tasks may then be sorted into line pool database 402 based on their priority. Many methods may be used to map quality requirements such as response latency into a priority value. For instance, the reciprocal of response latency can be used as the priority value. Similarity, the popularity of a web page (i.e., the click-through rate) can also be used to determine a priority value. Scheduler 404 categorizes the tasks into the priority lines shown in line pool database 402. For example, the highest priority tasks may be grouped to line 414 as the line with priority n line. The lowest priority tasks may be grouped to line 416 as the line with priority 1 line. Scheduler 404 then intermixes tasks from the different lines of line pool database 402 and feeds these to a gateway line database 406. Gateway line database 406 maintains a queue that buffers these mixed tasks from the input lines through line pool database 402. Intermixing may be performed based on a weighting algorithm where higher priority lines have more tasks pushed to gateway line database 406.

Gateway line database 406 distributes tasks to worker machines 408, 410, and 412 based on a distribution strategy determined by scheduler 404 which takes into account current tasks being performed by worker machines 408, 410, and 412, as well as the computational resources of the worker machines 408, 410, and 412. Tasks are pushed from gateway line database 406 to queues at each of the worker machines 408, 410, and 412. Scheduler 404 monitors the progress of each queue of worker machines 408, 410, and 412, and adjusts the distribution strategy dynamically. For example, if scheduler 404 notices that worker machine 408 is completing tasks at a much slower rate than the others, scheduler 404 will adjust the distribution strategy so that fewer tasks are sent to worker machine 408. Gateway line database 406 supports the dynamic change in task priorities and coordinates synchronization with tasks received and the queues in the worker machines 408, 410, and 412.

Distributed service scheduling server 240 serves as an administrative machine that distributes tasks to worker machines 408, 410, and 412. As discussed, the quantity of worker machines is variable. Additionally, distributed service scheduling server 402 can handle certain events such as the addition or removal of worker machines. For example, at certain points in time, some worker machines may become available and ready for processing of tasks. Distributed service scheduling server 402 will update its distribution strategy accordingly based on this event. Similarly, worker machines may fail or go down for maintenance. Distributed service scheduling server 402 will update its distribution strategy according to this event as well.

Priority lines such as lines 414 and 416, and 418 of line pool database 402 are used to organize input tasks. These lines may be implemented using a variety of methods such as a queue, first in first out queue, first in last out queue, or memory cache. Scheduler 404 is responsible for ensuring that mixed tasks from the priority lines are buffered to gateway line database 406 and also monitor progress of tasks that are eventually pushed from gateway line database 406 to worker machines such as worker machines 408, 410, and 412. For example, scheduler 404 may receive information indicative of the failure or completion of each given task served to worker machines 408, 410, and 412. Gateway line database 406 also includes a queue. Any queue-related technique can be implemented on any of the queues discussed with respect to FIG. 4 and with respect to the embodiments described herein.

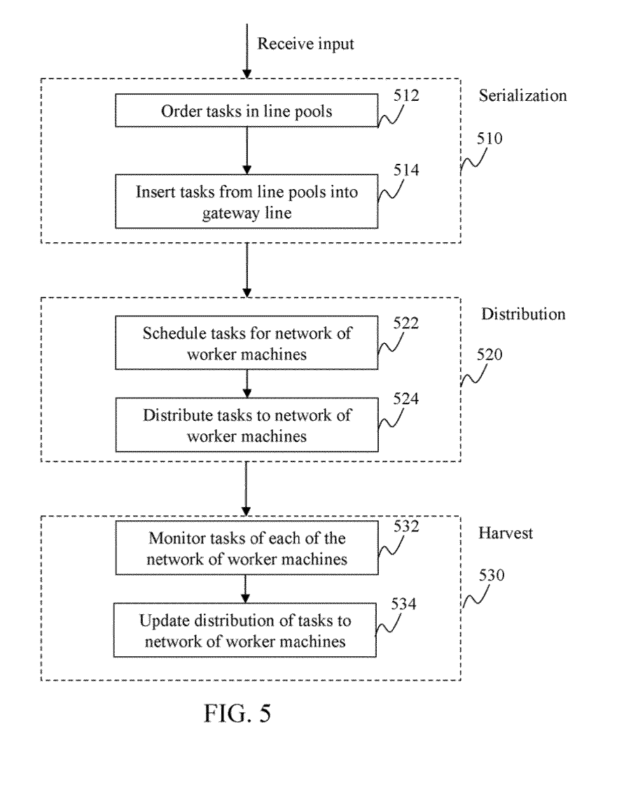

FIG. 5 depicts a flowchart of an exemplary process in which tasks are distributed to worker machines and in which distribution of tasks to worker machines are updated in accordance to an embodiment of the present disclosure. First stage 510, including steps 512 and 514, represents the serialization stage, where tasks are fetched from line pool database 402 and inserted into gateway line database 406 according to instructions from scheduler 404. Second stage 520, including steps 522 and 524, represents the distribution stage, where tasks buffered at gateway line database 406 are pushed to queues on worker machines. Third stage 530, including steps 532 and 534, represents the harvest stage, where scheduler 404 monitors and checks the status of tasks being processed by the worker machines.

At 512, tasks are ordered into line pools within line pool database 402. Tasks are received by distributed service scheduling server 340. Each task is mapped to a priority value and inserted into a corresponding line pool associated with that priority value. At 514, tasks are inserted from the line pools into a gateway line queue. Scheduler 404 intermixes tasks from each line of line pool database 402 and inserts these tasks into a queue at gateway line database 406. Steps 512 and 514 may also be carried out by a serialization unit of distributed service scheduling server 340.

At 522, tasks are scheduled for a network of worker machines. Scheduler 404, on the basis of factors including number of tasks, priority of tasks, workload of worker machines, and computational resources of worker machines, determines a distribution strategy for scheduling tasks to the network of worker machines. At 524, the tasks are distributed to the network of worker machines. Distribution of tasks is in accordance with the distribution strategy. Steps 512 and 514 may also be carried out by a distribution unit of distributed service scheduling server 340.

At 532, tasks distributed to the worker machines are monitored by scheduler 404. The status of each task is reported to scheduler 404. The status can include information such as whether the task was successfully completed, data (i.e., results) generated when the task is completed, the amount of time taken for the task to complete, errors encountered during performance of the task, or an indication that the task could not be completed after a certain number of retries. At 534, using any status information received based on tasks completed or failed by the current worker machines, scheduler 404 may update distribution of tasks to the worker machines. Using the status information, scheduler 404 may determine a new distribution strategy to maximize usage of all computational resources offered by the worker machines. The process depicted by FIG. 5 and described above may be repeated as necessary so long as there are tasks being input and tasks remaining to be performed by the worker machines.

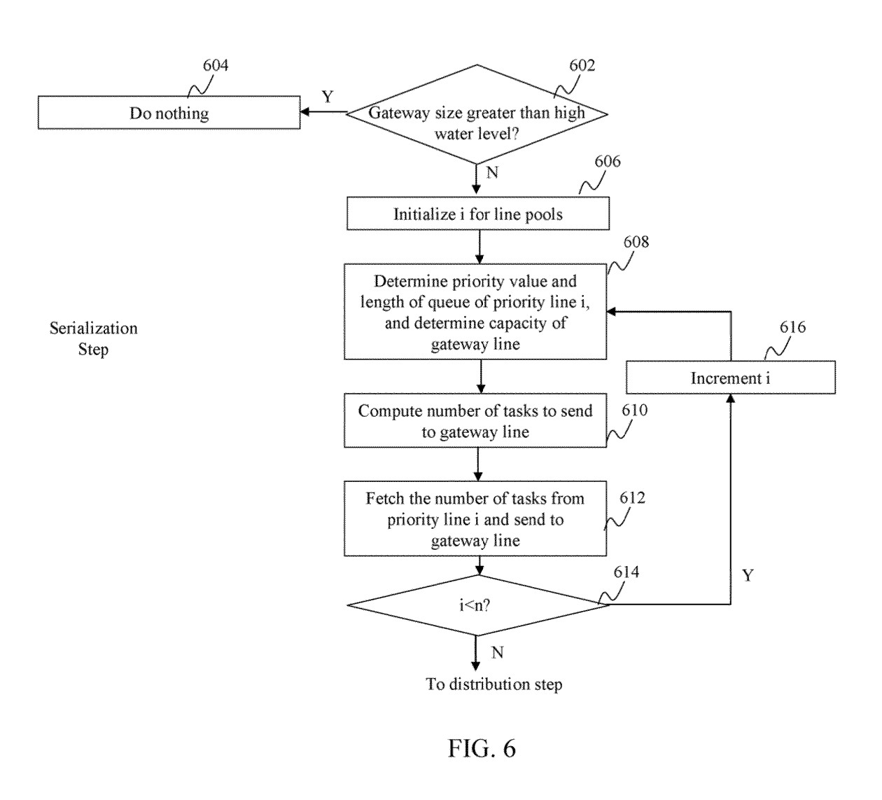

FIG. 6 depicts a flowchart of an exemplary process of a serialization step taken by a distributed service scheduling server in accordance with an embodiment of the present disclosure. FIG. 6 presents a more detailed flowchart of an exemplary serialization step or serialization stage process corresponding with serialization stage 510 of FIG. 5. This process may be carried out by components of distributed service scheduling server 340, or more specifically by a serialization unit of distributed service scheduling server 340. All steps of the exemplary process shown by FIG. 6 are for a given time epoch t. Each time epoch t, for example, may represent a period of time where new tasks are input and distributed. Since tasks may be continuously input, as time epoch t increments, the process for receiving and distributing the tasks is continuously performed as well.

At 602, a gateway line size is compared with a high water level. The gateway size at the given time t is represented by gₜ and the high water level represented by wₕ. The gateway size represents the current number of tasks in the gateway queue. The high water level represents a percentage (e.g., 80%) of the maximum number of tasks that the gateway queue should be holding. If gₜ>wₕ, then the process proceeds to step 604 to do nothing. If gₜ<wₕ, meaning that the current gateway size is less than the high water level, the process proceeds to 606.

At 606, index of priority lines in the line pool, represented by i, is initialized to zero so that the line pool can be traversed. Each priority line i is associated with a priority value. Tasks are assigned to the line pools based on their respective priorities.

For every given line i, steps 608, 610, and 612 are performed. At 608, a priority value, length of line (or queue) of priority line i, and capacity of the gateway are determined. The priority value of line i at a given time epoch t is represented by vₜ₍ᵢ₎. The length of the queue of line i at time epoch t is represented by pₜ₍ᵢ₎. Capacity of the gateway line, as mentioned above, is represented by gₜ.

At 610, the number of tasks to send to the gateway is computed. The number of tasks to be sent to the gateway is represented by aₜ₍ᵢ₎=vₜ₍ᵢ₎*min {pₜ₍ᵢ₎, (g−gₜ)}/sumᵢ{vₜ₍ᵢ₎}, where g is the initial chunk size—the number of tasks assigned to each worker machine.

At 612, the number of tasks to be sent to the gateway is fetched from line i and inserted into the gateway line.

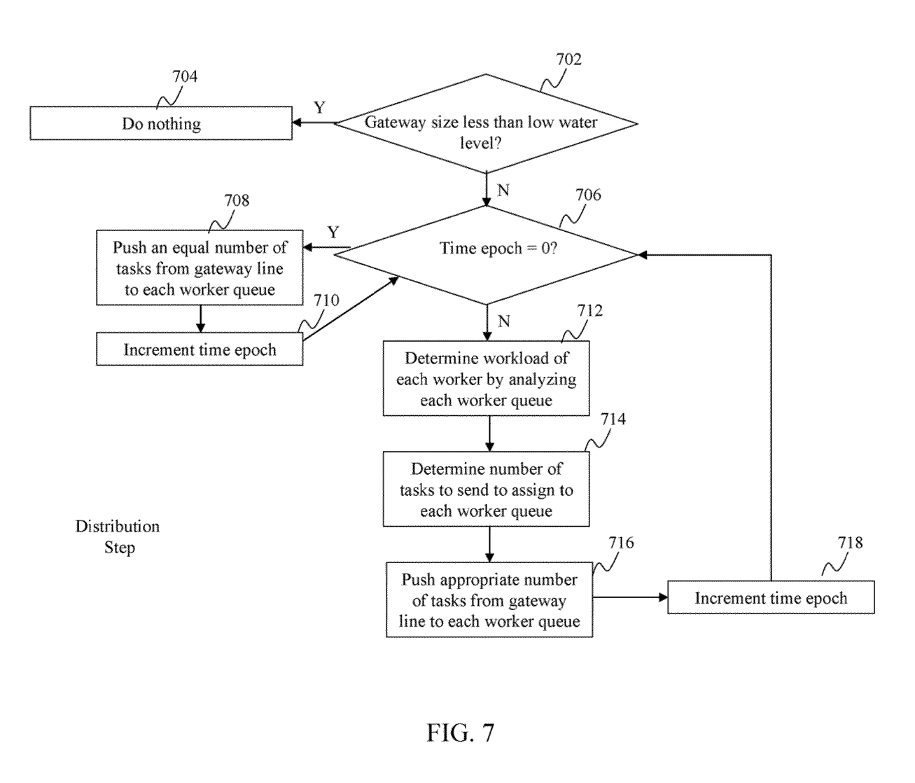

At 614, if i<n, where n represents the number of priority lines in priority line pool, then the process proceeds to 616, where i is incremented and steps 608, 610, and 612 are repeated. If i>=n, then the process proceeds to the distribution stage corresponding to 520 of FIG. 5, and which will be discussed in greater detail with respect to FIG. 7 below.

FIG. 7 depicts a flowchart of an exemplary process of a distribution step taken by a distributed service scheduling server in accordance with an embodiment of the present disclosure. FIG. 7 presents a more detailed flowchart of an exemplary process in distribution stage (or distribution steps) corresponding to distribution stage 520 of FIG. 5. This process may be carried out by components of distributed service scheduling server 340, or more specifically by a distribution unit of distributed service scheduling server 340. All steps of the exemplary process shown by FIG. 7 are for a given time epoch t. At 702, the gateway size is compared with a low water level, a percentage (e.g., 20%) of the maximum number of tasks that can be held by the gateway line. The gateway size is represented by gₜ. The low water level is represented by wₗ. If gₜ<wₗ, then the process proceeds to step 704 to do nothing. If gₜ>wₗ, then the process proceeds to 706.

At 706, it is determined if the time epoch is 0, or t==0. If the time epoch were 0, this would signify that tasks would need to be distributed. Thus, if t==0, the process proceeds to 708, where an equal number of tasks are pushed to each worker queue of each worker machine from the gateway line. More specifically, for each queue on a worker machine i (i=0, 1, . . . , (m−1)), the length of the queue on host i at time epoch t, is represented by qₜ₍ᵢ₎=(hₒ/m) is fetched. Here, hₜ represents the number of tasks to push to worker machines at a given time epoch t and m represents the number of worker machines. These tasks are then pushed into each queue on host i. The process then proceeds to 710 where time epoch t is incremented so that the process can return to 706.

At 706, if it is determined that t is not equal to 0, then the process proceeds to 712. At 712, the workload of each worker machine is determined by analyzing the tasks of each worker queue. Thus, for each worker machine i (i=0, 1, . . . , (m−1)), qₜ₍ᵢ₎ is fetched to determine the length of each worker queue. The process proceeds to 714, where the number of tasks to assign to each worker queue is determined. For each worker machine i, the number of tasks is computed, taking the form dₜ₍ᵢ₎={q₍ₜ₋₁₎₍ᵢ₎−qₜ₍ᵢ₎}. The sum is then computed as dₜ=sumᵢ {dₜ₍ᵢ₎}, setting h=hₜ+sumᵢ {qₜ₍ᵢ₎} where hₜ represents the total number of tasks to push to the worker machines at time epoch t, and h is the number of tasks to be assigned to worker machines at current epoch.

At 716, an appropriate number of tasks are pushed from the gateway line to each worker queue where each worker queue corresponds to a worker machine. For a queue on worker machine i in non-descending order of qₜ₍ᵢ₎, a number of tasks aₜ₍ᵢ₎ are computed, where aₜ₍ᵢ₎={dₜ₍ᵢ₎/dₜ}*h−qₜ₍ᵢ₎. The number of tasks is then fetched and pushed to the queue on worker machine i. Then h may be updated accordingly to be h={h−aₜ₍ᵢ₎} and qₜ₍ᵢ₎ updated to be qₜ₍ᵢ₎={qₜ₍ᵢ₎+aₜ₍ᵢ₎}. The process may then proceed to 718 where time epoch t is updated so that the process returns to 706.

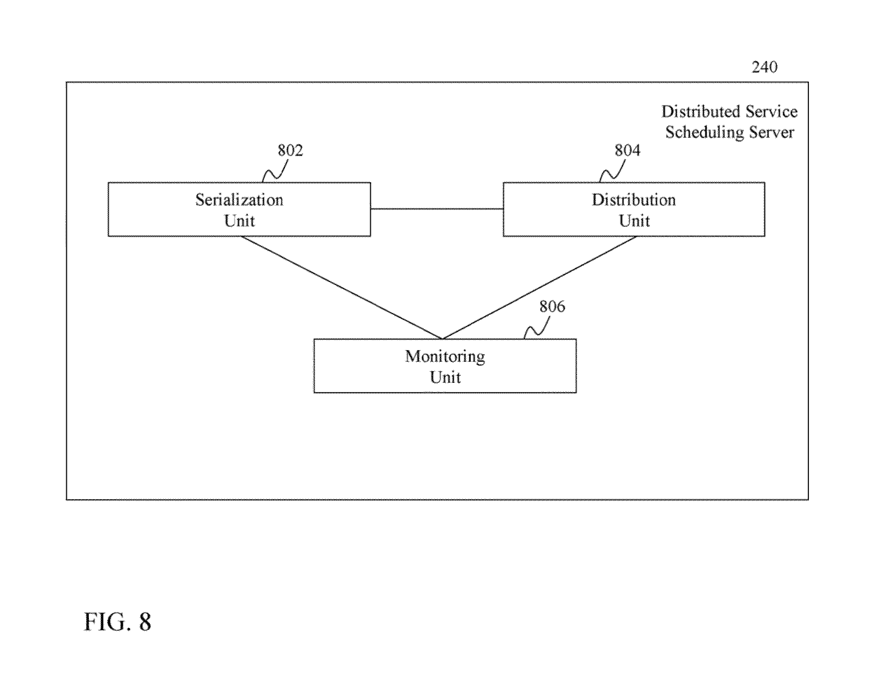

FIG. 8 depicts a high level exemplary system diagram of a distributed service scheduling server in accordance with an embodiment of the present disclosure. Distributed service scheduling server 240 may be represented from a high level by the components including a serialization unit 802, distribution unit 804, and monitoring unit 806. Serialization unit 802 is responsible for carrying out serialization stage 520 shown by FIG. 5 and described above, and the steps of the serialization stage shown by FIG. 6 and described above. Distribution unit 804 is responsible for carrying out distribution stage 530 shown by FIG. 5 and described above, and the steps of the distribution stage shown by FIG. 7 and described above. Monitoring unit 806 is responsible for carrying out the harvest stage 540 shown by FIG. 5 and described above. Monitoring unit 806 is additionally responsible for determining the status of tasks deployed to worker machines. The status of the task may either indicate successful completion of the task or failure of the task. Reasons for failure may include network related issues, operating system or machine malfunctions, or unavailable system resources. For a failed task, monitoring unit 806 of distributed service scheduling server 240 may instruct the worker machine that was responsible for the task to reinsert the task into the worker queue a predetermined number of times until the task succeeds. Monitoring unit 806 may also move the task back to the gateway line to be sent to a different worker machine. Results for tasks may additionally be delivered to a user by push methods or pull methods.

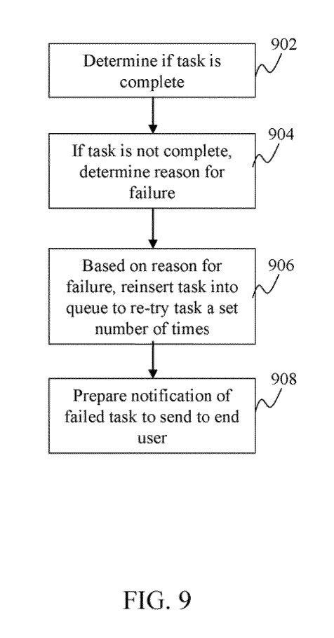

FIG. 9 depicts a flowchart of an exemplary process of handling task failures in accordance with an embodiment of the present disclosure. At 902, a determination of whether a task at any given worker machine is complete is made by distributed service scheduling server 240. At 904, if the task is not complete, a reason for the failure is determined. Reasons for failure may vary and include network related issues, operating system or machine malfunctions, or unavailable system resources. At 906, based on the reason for failure, the task may be reinserted into the queue of the worker machine responsible for the task to re-try the task a set number of times. At 908, if the task is still not completed, notifications can be prepared to send to an end user or machine from which the task originated.

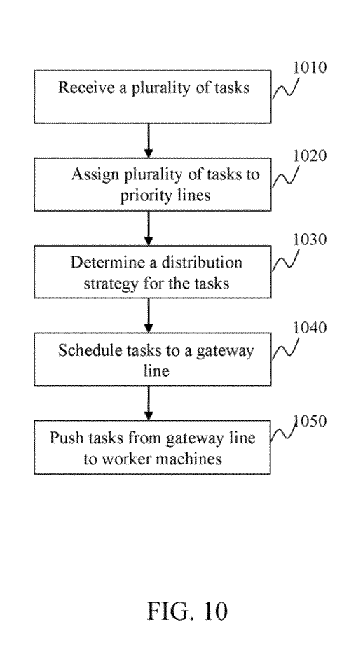

FIG. 10 depicts a flowchart of an exemplary process in which tasks are scheduled to worker machines in accordance with an embodiment of the present disclosure. At 1010, a plurality of tasks is received by distributed service scheduling server 340, where each task has an associated priority level. The tasks may relate to tasks required by a search engine or a user device or any activity performed over a network.

At 1020, the plurality of tasks is assigned to different priority lines on the basis of the priority of each task. A priority of each task may be represented by a numerical value, where a higher numerical value indicates a higher task priority. The numerical value may be matched with a numerical value of a priority line to determine which priority line to assign the task to.

At 1030, a distribution strategy for the plurality of tasks is determined based on an analysis of the priority levels of each task and based on an analysis of the worker machines. Analysis of the worker machines may include an analysis of the capabilities of each worker machine based on their computational resources, as well as analyzing a worker queue of each worker machine to track the progress of each worker machine's completion of tasks.

At 1040, a group of tasks from the plurality of priority lines are scheduled to a gateway line based on the distribution strategy. This entails determining a distribution of tasks based on a number of tasks in each of the plurality of priority lines, and pushing certain tasks from the plurality of priority lines based on the determined distribution. In essence, a mixture of the tasks from each of the priority lines are selected and pushed to the gateway line.

At 1050, tasks are pushed from the gateway line to the worker machines to process the tasks. The tasks are pushed to the worker machines also on the basis of the distribution strategy. For example, if certain worker machines have higher computational processing resources, then those worker machines may be pushed tasks more often from the gateway line. Conversely, if certain worker machines are slow and not processing quickly, then they will not receive many tasks to perform.

A new distribution strategy may also be determined at predetermined time intervals in response to new tasks that are received and assigned to the plurality of priority lines. Since tasks may be arriving continuously, at certain times, distributed service scheduling server 240 may need to reevaluate its distribution strategy to take full advantage of all of the resources offered by the worker machines. The progress of each worker machine may also be monitored to determine if tasks are successfully completed or are failing. For example, if a failed task is determined at a worker machine, distributed service scheduling server 240 may determine the reason associated with the failed task. Based on this reason, the task may be reinserted into the queue of the worker machine for reprocessing. On the other hand, the task may be reinserted into the gateway line to be sent to a different worker machine. If repeated attempts to complete the task fail, then an error notification may be sent to the originator of the task.

To implement the embodiments set forth herein, computer hardware platforms may be used as hardware platform(s) for one or more of the elements described herein (e.g., distributed service scheduling server 240, worker machines 250, line pool database 402, scheduler 404, gateway line database 406, serialization unit 802, distribution unit 804, and monitoring unit 806.). The hardware elements, operating systems and programming languages of such computer hardware platforms are conventional in nature, and it is presumed that those skilled in the art are adequately familiar therewith to adapt those technologies to implement any of the elements described herein. A computer with user interface elements may be used to implement a personal computer (PC) or other type of workstation or terminal device, although a computer may also act as a server if appropriately programmed. It is believed that those skilled in the art are familiar with the structure, programming, and general operation of such computer equipment, and as a result the drawings are self-explanatory.

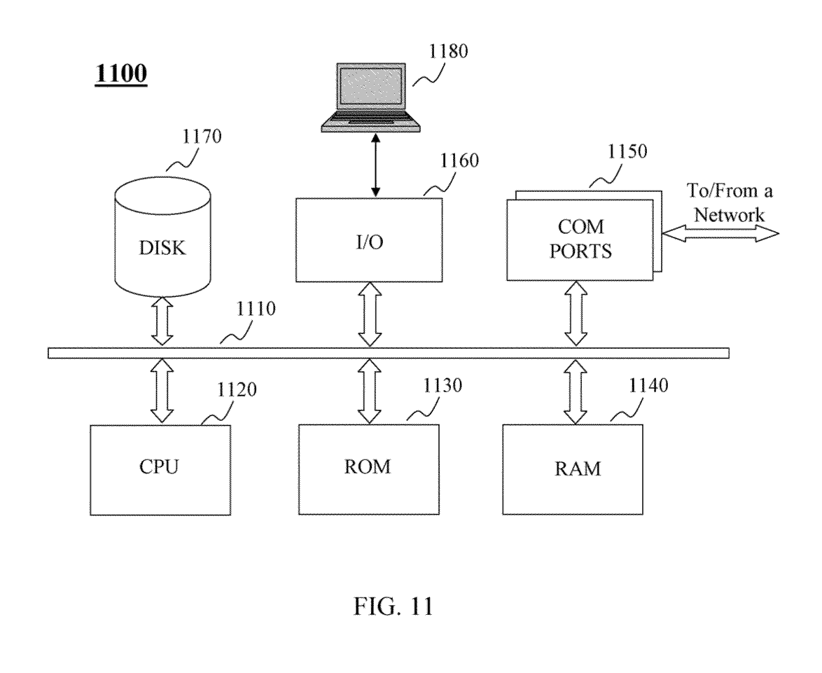

FIG. 11 depicts a general computer architecture on which the present embodiments can be implemented and has a functional block diagram illustration of a computer hardware platform which includes user interface elements. The computer may be a general purpose computer or a special purpose computer. This computer 1100 can be used to implement any components of the development and hosting platform described herein. For example, distributed service scheduling server 240, worker machines 250, line pool database 402, scheduler 404, gateway line database 406, serialization unit 802, distribution unit 804, and monitoring unit 806, can all be implemented on a computer such as computer 1100, via its hardware, software program, firmware, or a combination thereof. Although only one such computer is shown, for convenience, the computer functions relating to development and hosting of applications may be implemented in a distributed fashion on a number of similar platforms, to distribute the processing load.

The computer 1100, for example, includes COM ports 1150 connected to and from a network connected thereto to facilitate data communications. The computer 1100 also includes a central processing unit (CPU) 1120, in the form of one or more processors, for executing program instructions. The exemplary computer platform includes an internal communication bus 1110, program storage and data storage of different forms, e.g., disk 1170, read only memory (ROM) 1130, or random access memory (RAM) 1140, for various data files to be processed and/or communicated by the computer, as well as possibly program instructions to be executed by the CPU. The computer 1100 also includes an I/O component 1160, supporting input/output flows between the computer and other components therein such as user interface elements 1180. The computer 1100 may also receive programming and data via network communications.

Hence, aspects of the methods of developing, deploying, and hosting applications that are interoperable across a plurality of device platforms, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated schedules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, from a server or host computer into the hardware platform(s) of a computing environment or other system implementing a computing environment or similar functionalities in connection with generating explanations based on user inquiries. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media includes dynamic memory, such as a main memory of such a computer platform. Tangible transmission media includes coaxial cables, copper wire, and fiber optics, including wires that form a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic take, any other magnetic medium, a CD-ROM, DVD or DVD-ROM, any other optical media, punch card paper tapes, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Those skilled in the art will recognize that the embodiments of the present disclosure are amenable to a variety of modifications and/or enhancements. For example, although the implementation of various components described above may be embodied in a hardware device, it can also be implemented as a software only solution—e.g., an installation on an existing server. In addition, the dynamic relation/event detector and its components as disclosed herein can be implemented as firmware, a firmware/software combination, a firmware/hardware combination, or a hardware/firmware/software combination.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim and all applications, modifications and variations that fall within the true scope of the present teachings.

1. A method implemented on at least one computing device, each computing device having at least one processor, storage, and a communication platform connected to a network for distributing tasks to a network of machines, the method comprising:
receiving a plurality of tasks, each task having an associated priority level;
assigning each of the plurality of tasks to a priority line of a plurality of priority lines based on the associated priority level of each of the plurality of tasks;
determining a distribution strategy for the plurality of tasks based on an analysis of at least one worker machine;
scheduling a group of tasks from the plurality of priority lines to a gateway line based on the distribution strategy; and
pushing tasks from the gateway line to the at least one worker machine to process the tasks.

2. The method of claim 1, wherein the plurality of tasks relate to tasks required by a search engine.

3. The method of claim 1, wherein scheduling a group of tasks from the plurality of priority lines to a gateway line based on the distribution strategy comprises:
determining a distribution of tasks based on the number of tasks in each of the plurality of priority lines;
pushing tasks from each of the plurality of priority lines based on the determined distribution.

4. The method of claim 1, wherein determining a distribution strategy for the plurality of tasks based on an analysis of at least one worker machine comprises:
analyzing the dynamics of priority line pool and capacity of gateway line, and
analyzing the progress of tasks processed by each of the at least one worker machine.

5. The method of claim 1, further comprising:
determining a new distribution strategy at predetermined time intervals in response to new tasks received and assigned to the plurality of priority lines.

6. The method of claim 1, further comprising:
monitoring a progress of each of the at least one worker machine processing the pushed tasks.

7. The method of claim 1, further comprising:
determining a failed task at a worker machine;
determining a reason associated with the failed task; and
reinserting the failed task into a queue at the worker machine for reprocessing of the failed task.

8. A machine readable non-transitory and tangible medium having information recorded for distributing tasks to a network of machines, wherein the information, when read by the machine, causes the machine to perform the steps comprising:
receiving a plurality of tasks, each task having an associated priority level;
assigning each of the plurality of tasks to a priority line of a plurality of priority lines based on the associated priority level of each of the plurality of tasks;
determining a distribution strategy for the plurality of tasks based on an analysis of at least one worker machine;
scheduling a group of tasks from the plurality of priority lines to a gateway line based on the distribution strategy; and
pushing tasks from the gateway line to the at least one worker machine to process the tasks.

9. The machine readable non-transitory and tangible medium of claim 8, wherein the plurality of tasks relate to tasks required by a search engine.

10. The machine readable non-transitory and tangible medium of claim 8, wherein scheduling a group of tasks from the plurality of priority lines to a gateway line based on the distribution strategy comprises:
determining a distribution of tasks based on a number of tasks in each of the plurality of priority lines;
pushing tasks from each of the plurality of priority lines based on the determined distribution.

11. The machine readable non-transitory and tangible medium of claim 8, wherein determining a distribution strategy for the plurality of tasks based on an analysis of at least one worker machine comprises:
analyzing the dynamics of priority line pool and capacity of gateway line, and
analyzing the progress of tasks processed by each of the at least one worker machine.

12. The machine readable non-transitory and tangible medium of claim 8, wherein the information, when read by the machine, causes the machine to further perform the step comprising:
determining a new distribution strategy at predetermined time intervals in response to new tasks received and assigned to the plurality of priority lines.

13. The machine readable non-transitory and tangible medium of claim 8, wherein the information, when read by the machine, causes the machine to further perform the step comprising:
monitoring a progress of each of the at least one worker machine processing the pushed tasks.

14. The machine readable non-transitory and tangible medium of claim 8, wherein the information, when read by the machine, causes the machine to further perform the step comprising:
determining a failed task at a worker machine;
determining a reason associated with the failed task; and
reinserting the failed task into a queue at the worker machine for reprocessing of the failed task.

15. A system for distributing tasks to a network of machines, comprising:
a serialization unit for receiving a plurality of tasks, each task having an associated priority level, and assigning each of the plurality of tasks to a priority line of a plurality of priority lines based on the associated priority level of each of the plurality of tasks; and
a distribution unit for determining a distribution strategy for the plurality of tasks based on an analysis of at least one worker machine, scheduling a group of tasks from the plurality of priority lines to a gateway line based on the distribution strategy, and pushing tasks from the gateway line to the at least one worker machine to process the tasks.

16. The system of claim 15, wherein the plurality of tasks relate to tasks required by a search engine.

17. The system of claim 15, wherein the distribution unit is further configured for determining a distribution of tasks based on a number of tasks in each of the plurality of priority lines; pushing tasks from each of the plurality of priority lines based on the determined distribution.

18. The system of claim 15, wherein the distribution unit is further configured for analyzing a progress of a queue of each of the at least one worker machine.

19. The system of claim 15, wherein the distribution unit is further configured for determining a new distribution strategy at predetermined time intervals in response to new tasks received and assigned to the plurality of priority lines.

20. The system of claim 15, further comprising:
a monitoring unit for monitoring a progress of each of the at least one worker machine processing the pushed tasks.

21. The system of claim 15, wherein the distribution unit is further configured for determining a failed task at a worker machine; determining a reason associated with the failed task; and reinserting the failed task into a queue at the worker machine for reprocessing of the failed task.
